(19) United States
(12) Patent Application Publication
(10) Pub. No.: US 2017/0213213 A1
(43) Pub. Date: Jul. 27, 2017

(54) ENHANCED AUTHENTICATION SECURITY APPLICABLE IN AN AT LEAST PARTIALLY INSECURE NETWORK ENVIRONMENT

(71) Applicant: Sigue Corporation, Sylmar, CA (US)

(72) Inventor: Max Stanford Tomlinson, JR., Stevenson Ranch, CA (US)

(21) Appl. No.: 15/005,807

(22) Filed: Jan. 25, 2016

(51) Int. Cl. G06Q 20/40; G06Q 20/32; H04L 29/06

(52) U.S. Cl. CPC G06Q 20/401; H04L 63/102; H04L 63/0876; G06Q 20/3227; G06Q 2220/10

(57) ABSTRACT

Systems and methods are provided for enhancing the security of a multi-system transaction environment in which the computer hardware and/or software of at least one device participating in transaction authorization does not support encrypted communications, and/or where at least one communication associated with the transaction is sent over a network in a manner that will likely be capable of being intercepted, listened to or monitored by an untrusted party. An authorization service may maintain two different codes associated with each of a number of different clients or client devices. Transaction requests may be initiated by a transaction request system using a first code and a client identifier, and confirmed by a client device using a second code, with both codes being communicated in separate transmissions to an authorization service via potentially different networks.

### BACKGROUND

Modern mobile phones, some of which may be referred to as “smartphones,” often offer many hardware and software features that were not included in standard mobile phones less than a decade ago. For example, current smartphones typically include Global Positioning System (“GPS”) capability, Internet access via cellular or Wi-Fi networks, have a touchscreen, include an accelerometer or other motion sensor(s), and are operated using an operating system capable of executing a variety of downloadable third-party software applications. While mobile phones with these and other advanced features are becoming commonplace in many markets, there are specific markets, countries and regions in which less technologically sophisticated mobile phones remain in widespread use. For example, a class of mobile phones sometimes referred to as “feature phones” typically do not have the capability to download and execute software applications, and may have functionality limited primarily to enabling the user to verbally communicate wirelessly and to send and receive standard text messages (such as Short Message Service or “SMS” messages). Even in countries or markets in which more advanced smartphones are the most common class of mobile phones used by individuals, wireless carriers typically continue to support and provide cellular service to individuals who use feature phones or other less advanced cellular devices.

Given the high percentage of individuals who own smartphones in many markets, companies have been increasingly relying on advanced hardware and/or software features inherent in many recently manufactured smartphones when developing new products and services to be used in conjunctions with mobile phones. For example, a variety of products or services enable individuals who owns certain smartphones to purchase products by allowing a vendor's device to interact with radio-frequency identification (“RFID”) or near field communication (“NFC”) features of many smartphones. As another example, some third-party services require that a user's device is capable of communicating using certain encryption techniques or standards in order to use a given service from the user's mobile phone. Because many of these and other services assume or rely upon an individual's use of a smartphone having certain minimum functionality, individuals who use a feature phone or other mobile device that is limited to more basic voice and text message functionality are often unable to use such services. Alternatively, a feature phone user may be able to use some such services, but may do so in a manner that compromises (either knowingly or unknowingly to the user) the security of the user's communications, personal information, payment information or other data because the service was designed to be secure only with respect to devices capable of functionality that is missing in the user's device.

### BRIEF DESCRIPTION OF THE DRAWINGS

The foregoing aspects and many of the attendant advantages will become more readily appreciated as the same become better understood by reference to the following detailed description, when taken in conjunction with the accompanying drawings, wherein:

FIG. 1 depicts an illustrative operating environment in which an authorization service communicates with a transaction request system and a client device via one or more networks.

FIG. 2 is a block diagram illustrating an authorization service authorizing an electronic transaction within the operating environment of FIG. 1.

FIG. 3 depicts a general architecture of an example computing system for providing an authorization service.

FIG. 4 is a flow diagram of an illustrative method implemented by an authorization service for authorizing an electronic transaction and/or authenticating the source of a transaction request.

FIG. 5 depicts an example automated text message, as displayed on a mobile computing device, which may be generated by an authorization service.

These and other features will be described herein with reference to the drawings summarized above. The drawings and the associated descriptions are provided to illustrate certain embodiments and not to limit the scope of the invention.

### DETAILED DESCRIPTION

Aspects of the present disclosure relate to providing enhanced security for a variety of electronic transactions and/or authentication attempts, which are applicable for use in a network environment in which at least one communication associated with the transaction is likely to be sent over a network in a manner that will likely be capable of being intercepted, listened to or monitored by an untrusted party. For example, one of the problems addressed by the present disclosure is that certain mobile computing devices (such as certain mobile phones or other communications devices) may be limited to receiving incoming communications via an unencrypted standard communication method (such as SMS messages) via wireless networks that are vulnerable to eavesdropping by nefarious parties. There is a risk that even if a multi-system distributed transaction includes a number of secure communications, the entire transaction may nevertheless be considered compromised if it includes even a single communication to one device in an insecure manner, provided that other safeguards like those described herein are not employed. Aspects of the present disclosure provide enhanced transaction security and account security in such instances, in some embodiments, without requiring that the content of the potentially vulnerable communication (or the weak link in an otherwise secure multi-system transaction environment) be encrypted, scrambled or otherwise altered from an easily understandable form before being sent over the air or via some other potentially insecure communication method.

Generally, the radio signals that carry SMS text messages are sent in the clear, and anyone with appropriate and reasonably available equipment can eavesdrop and capture all text messages sent in a given geographic area. Thus, sending a standard SMS text message that includes privileged information within the content of the message would not be considered secure by those of skill in the art for at least the reason that such privileged information would be deemed comprisable.

Known methods exist for encrypting text messages, but such methods typically require specific hardware on the user device and/or configuration by a specific carrier or service provider. Because existing text message encryption techniques typically require significant involvement by a communications carrier (such as to supply a specific factory-configured device) or require that customers buy and install additional hardware, such encryption techniques are not universally applicable to, or compatible with, all existing SMS-capable mobile phones without significant involvement by the carrier or an after-market hardware provider.

Another problem addressed by the present disclosure is associated with the possibility that a telephone number of a particular mobile phone can be cloned for nefarious purposes. Thereafter, a hijacked device can send and receive phone calls and text message as if it were a given individual's own mobile phone. The possibility of phone cloning means that a system receiving a text message that purportedly originated from a particular individual's mobile phone number is insufficient to establish that the message actually originated from the given individual or even from the individual's device. The cloning problem is especially present in transaction systems and methods in which a significant number of users of the system or method utilize feature phones or other mobile devices that lack hardware or software capabilities for encryption or otherwise enhanced communication security.

Aspects of the present disclosure, according to some embodiments, provide transaction authorization that is compatible with a feature phone (such as a phone that can receive SMS messages, but is potentially incapable of encryption and other more advanced smartphone features), yet precludes malicious stealing of enough user credential information to be sufficient to authorize a transaction. In some embodiments, the enhanced security described herein may be provided even when unencrypted text messages are intercepted or feature phones are cloned. For example, according to some embodiments, a criminal who clones a legitimate user's phone would still lack two user-specific codes (referred to herein, for example, as a shared code and a private code) that would be required in some embodiments to authorize a future electronic transaction on behalf of the legitimate user. Additionally, according to some embodiments, an authorization process described herein may be such that both codes are never sent in the same communication or even via the same network, which may significantly lower the likelihood that a criminal can successfully authorize a transaction purportedly originating from the legitimate user.

In one embodiment, an authorization service that includes one or more computing devices may receive, within an encrypted transmission, an electronic transaction request from a first remote computing system, such as a transaction request system operated by an entity that is requesting to initiate an electronic transaction purported to have been initiated by a specific individual or client. The authorization service may then determine a client identifier and a first code within the electronic transaction request at least in part by processing the encrypted transmission, such as by decrypting the message and extracting data from specific fields. The authorization service may determine that the electronic transaction request corresponds to a given client account at least in part by matching the client identifier within the electronic transaction request with a first client identifier previously stored in the electronic data store, such as a data store that includes account information for a potentially large number of different clients of the authorization service. The authorization service may validate the first code at least in part by determining that the first code within the electronic transaction request matches a shared code associated with the first account in the electronic data store. Upon validation of the first code, the authorization service may generate a text message that includes both information regarding the electronic transaction request and a request for transaction authorization. The authorization service may send the text message to a mobile computing device using a phone number stored in the electronic data store in association with the first account, such as by sending the message to the phone number in unencrypted form using SMS. When a responsive text message is received by the authorization service from the same mobile computing device, the authorization service may validate the responsive text message by confirming that at least a portion of text content within the responsive text message matches a previously stored private code associated with the first account in the electronic data store. If the responsive text message is successfully validated, the authorization service may send an electronic transaction approval indication to the first computing system that initiated the transaction request. If validation fails, the authorization service may instead send a transaction denial indication to the first computing system.

In some embodiments, the shared code and the private code may have distinct characteristics that reduce the likelihood of confusing one code for the other. For example, the shared code may be a series of numbers and the private code may be a series of letters. As a further example, the shared code or the private code may have a distinct prefix or suffix, checksum digits, or other characteristics that support distinguishing the codes. In further embodiments, the transaction request system or the mobile computing device may prevent the wrong code type (e.g., private code instead of shared code) from being entered, or may recognize that the wrong code has been entered and take corrective action. For example, the transaction request system may only allow numeric input (as opposed to letter input) when a shared code is being entered, such as by an application executed on a transaction request system displaying only number keys on a touchscreen-displayed virtual keyboard when prompting for entry of a shared code. As a further example, the transaction request system may determine that an entered code is not in the format of a shared code, and may display an error message instead of transmitting the entered code to the authorization service.

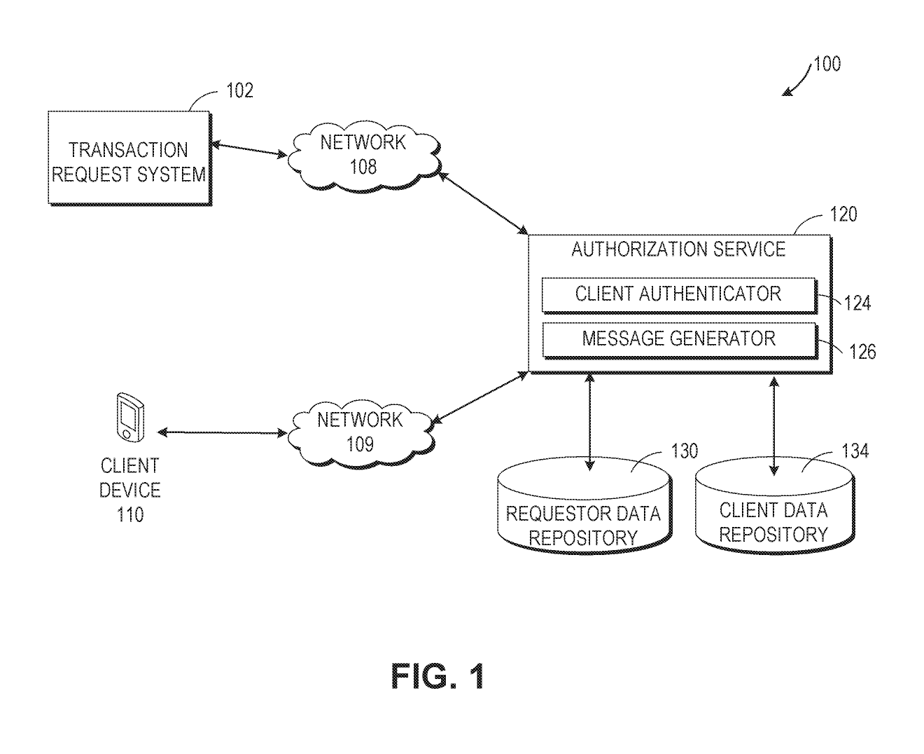

FIG. 1 depicts an illustrative operating environment 100 in which an authorization service 120 communicates with a transaction request system 102 and a client device 110 via one or more networks. Depending on the embodiment, the authorization service 120 may be represented in a single physical server or single computing device or, alternatively, may be split into multiple physical servers or other computing devices. While a single transaction request system and a single client device 110 are illustrated in FIG. 1 for ease of description, it will be appreciated that the authorization service 120 may be configured to process transaction requests that may originate from any of a potentially large number of different transaction request systems located in various geographic locations, and may be configured to authenticate or authorize transactions associated with any of a large number of different users and associated client devices.

The authorization service 120 may include a client authenticator 124 and a message generator 126 stored in memory therein that may be used to implement various aspects of the present disclosure, as will be further described below. In some embodiments, the client authenticator and message generator may each be stored as computer-executable instructions, while in other embodiments one or both of the client authenticator and/or message generator may be integrated within specialized hardware. Those skilled in the art will recognize that the client device 110 and the transaction request system 102 may each be any of a number of computing devices that are capable of communicating over a network. For example, the transaction request system 102 may include, but is not limited to, a laptop, desktop personal computer, tablet computer, point-of-sale (“POS”) system or terminal, mobile phone, smartphone, wearable computing device, gaming console, kiosk, augmented reality device, other wireless device, set-top or other television box, or other system. The client device 110 may be any computing device capable of being configured to receive SMS messages or other messages that the authorization service 120 is configured to send in a given embodiment, such as a mobile phone or other mobile computing device.

The authorization service 120 may be connected to and/or in communication with various electronic data stores, such as a requestor data repository 130 and/or a client data repository 134. The requestor data repository 130 may include account records for a variety of different entities and/or systems that are each registered with the authorization service 120 to request transaction authorizations via the authorization service. For example, according to some embodiments, a variety of third-party companies, organizations and/or individuals may register with the authorization service 120 prior to any given company, organization or individual sending transaction authorization requests to the authorization service 120. Some examples of a requestor that may have associated data stored in requestor data repository 130 (and which may also be an owner or operator of the illustrative transaction request system 102) may include a vendor, a retail store, a non-profit organization, a doctor's office, a government agency, a web site operator, a computer application developer or distributor, and/or any other organization, company or individual that desires to utilize the services of the authorization service 120 to authorize a transaction, verify a person's identity, or obtain other affiliated services provided by the authorization service 120 in a given embodiment. In other embodiments, the authorization service 120 may be configured to accept and process transaction requests originating from systems, companies or organizations that are not associated with any previously registered account with the authorization service 120, in which case a requestor data repository 130 may not be present.

Data or information stored in association with each transaction requestor account in requestor data repository 130 may include a requestor account identifier and a requestor code. The requestor code may be, for example, a series of numeric digits (such as “1033”) or may be an alphanumeric string (e.g., “CaHt9232”). In other embodiments, the requestor code may be a significantly longer series of bits or other data that may be stored as a file, such as a digital certificate or token. In some embodiments, the data stored in association with each requestor account in the requestor data repository 130 may include a variety of other information regarding an owner of the account and/or a transaction request computing system or device associated with the account. The additional information stored in the requestor data repository 130 in a given embodiment may depend on the type(s) of electronic transactions that the authorization service 120 is configured to authorize in the given embodiment. For example, if the requestor data repository 130 is configured to provide authorization for financial transactions, the requestor data repository 130 may store account balances. As another example, if the requestor data repository 130 is configured to provide authorization for the release of personal information associated with a user or client, the requestor data repository 130 may store information regarding the organization type that the account belongs to and/or an associated level of information access granted to the organization by the authorization service 120, by one or more clients, and/or by a third-party regulatory authority or other source.

Data or information stored in client data repository 134 in association with each client account may include a client account identifier, a shared code, and a private code. The shared code and private code may each be, but are not limited to, a series of numeric digits or an alphanumeric string. In some embodiments, the shared code and private code may each be considered to be a different personal identification number (or PIN code) associated with the client's account. The shared code stored for a given account would typically be different than the private code stored for the same account, and the authorization service 120 may enforce this difference as a requirement when establishing each code or accepting an initial or new code from a client, in some embodiments. The shared code may be considered “shared,” in some embodiments, in the sense that a given client may be required to provide his or her shared code to other individuals or computing systems (such as a transaction requestor entity or an associated transaction request system) as part of initiating a transaction. Accordingly, the shared code for a given client account may not be considered secure or private, at least with respect to the knowledge of a client's shared code by those transaction request systems or associated operators with whom the given client has interacted during a transaction request. In contrast, the private code of a given client may be considered private in the sense that the client can initiate and approve transactions without revealing his or her private code to any entity or system other than the authorization service 120.

As will be appreciated, other information may be stored in association with each client account in client data repository 134 in various embodiments, such as a mobile phone number, a device identifier (such as a MAC address, if applicable for a given device), information regarding the technical capabilities of the client's device (such as whether it supports encryption or other security protocols or standards), an account balance, a full name, personal information, data to potentially be released to requestors upon transaction approval by the authorization service 120, and/or other information. In some embodiments, a client's mobile phone number may serve as the client's account identifier, while in other embodiments a separate account identifier and mobile phone number may be stored for a given account.

In some embodiments, each of requestor data repository 130 and client data repository 134 may be local to authorization service 120, may be remote from the authorization service 120, and/or may be a network-based service itself. The requestor data repository 130 and client data repository 134 may be embodied in hard disk drives, solid state memories, any other type of non-transitory computer-readable storage medium, and/or a file, a database, a relational database, in-memory cache, and/or stored in any such non-transitory computer-readable medium accessible to the authorization service 120. The requestor data repository 130 and client data repository 134 may also be distributed or partitioned across multiple local and/or remote storage devices without departing from the spirit and scope of the present disclosure. In some embodiments, the data referred to herein as being stored in the requestor data repository 130 and the data referred to herein as being stored in the client data repository 134 may be stored in a single data store.

In the environment shown in FIG. 1, the transaction request system 102 and the client device 110 each communicate with the authorization service 120 via the same or different communication network(s), depending on the environment. In some embodiments, the network 108 may be a personal area network, local area network, wide area network, cable network, satellite network, cellular telephone network, etc. or combination thereof. For example, the network 108 may be a publicly accessible network of linked networks, possibly operated by various distinct parties, such as the Internet. In some embodiments, the network 108 may be a private or semi-private network, such as a corporate intranet. The network 108 may include one or more wireless networks, such as a Global System for Mobile Communications (GSM) network, a Code Division Multiple Access (CDMA) network, a Long Term Evolution (LTE) network, or some other type of wireless network. The network 108 can use protocols and components for communicating via the Internet or any of the other aforementioned types of networks. Protocols and components for communicating via the Internet or any of the other aforementioned types of communication networks are well known to those skilled in the art and, thus, are not described in more detail herein. In some embodiments, the network 109 may be a cellular telephone network capable of delivering SMS messages to feature phones or other mobile devices. In other embodiments, the network 109 may be any of the other network types mentioned above or similar, including but not limited to the Internet.

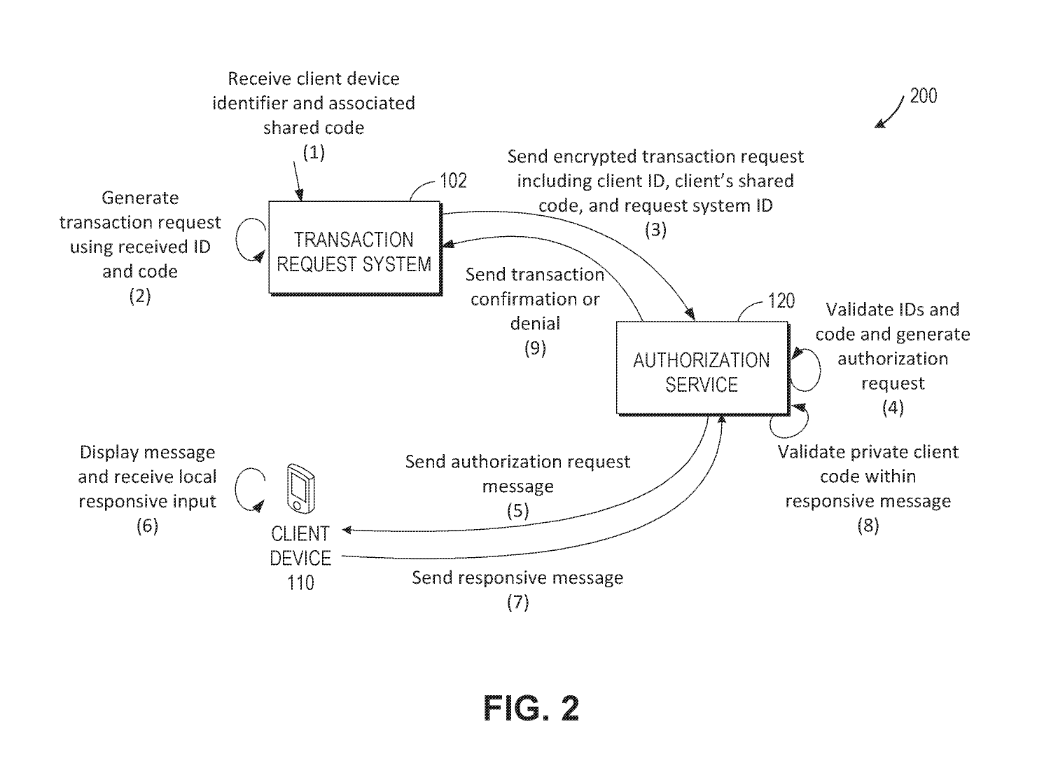

FIG. 2 is a block diagram illustrating the authorization service 120 authorizing an electronic transaction within the operating environment of FIG. 1. The illustrated flow 200 begins with the transaction request system 102 receiving a client device identifier (or client account identifier, in other embodiments) and an associated shared code. The client device identifier and shared code may be provided to the transaction request system by a human operator of the transaction request system, such as using a keyboard, touchscreen or voice input. In some embodiments, a person who is a client of the authorization service 120 and who has previously established an account with the authorization service 120 may verbally provide his client identifier and shared code to an operator of the transaction request system (such as a store clerk at a physical retail store, a doctor's office assistant, a teller at a bank or some other operator) as part of an in-person interaction. In other embodiments, some of the provided information (such as a client device identifier) may be communicated from a mobile computing device or other device of the client to the transaction request system 102 while the client's device is physically near to the transaction request system 102, such as using NFC, Bluetooth, an optical code (such as a barcode or Quick Response Code scanned by an optical reader), or RFID.

For example, a client may desire to initiate a transaction with the operator of the transaction request system in order pay for good or services, to establish the client's identity, to authorize release of electronic information regarding the client to the transaction request system from the authorization service, or some other transaction purpose in accord with a given embodiment. In some embodiments, the client may provide his mobile phone number (which may serve as the client's account identifier with the authorization service) to the operator of the transaction request system for sending to the authorization service along with the shared code. In other embodiments, the client's account identifier may be a unique number, word or string previously established between the client and the authorization service to uniquely identify the client and/or the client's account with the authorization service. One potential advantage to embodiments in which an account name other than a mobile phone number is utilized is that such an embodiment limits the ability of nefarious individuals who overhear a client speak in-person with the operator of the transaction request system from learning the client's phone number (which could otherwise potentially assist the nefarious individual in obtaining the client's private code by subsequently searching eavesdropped cellular communications in the area for signals originating from the phone having the given phone number).

Once the client identifier and shared code provided by the individual representing himself to be the given client are provided to or entered in the transaction request system 102, the transaction request system 102 generates a transaction request that includes the entered client identifier and shared code, along with other transaction request information. The other transaction request information may include a requestor identifier associated with the transaction request system 102, and a description of the requested transaction (such as a name of a good to be purchased and an associated price, in the case of a purchase transaction, or some other description appropriate for a non-financial transaction). In some embodiments, the transaction request may be generated by a software application developed by the operator of the authorization service 120 that was previously provided to the transaction request system (such as an application developed for a POS system, a tablet computer, a laptop or some other computing system used as the transaction request system 102 in a given embodiment). In other embodiments, the transaction information may be entered via a secure webpage (such as a webpage that utilizes Transport Layer Security, Secure Sockets Layer, or other security technology) or other secure user interface provided by or generated by the authorization service 120 and sent to the transaction request system 102 for display. Whether the transaction request is generated by an application associated with the authorization service, a webpage displayed within a browser program, or in another manner, the information of the request may be encrypted by the transaction request system 102 and/or other associated hardware (such as a network router) using known methods prior to the request being communicated over a network, such as network 108. The encryption or other security steps for protecting the network communication of the client's shared code may prevent a nefarious party from electronically eavesdropping or intercepting network communications to learn of the client's shared code, thereby providing an account safeguard in the event that the nefarious party is able to subsequently intercept a second code of the client's account in a later unencrypted SMS communication.

As illustrated in FIG. 2, the transaction request generated by the transaction request system 102 is communicated in a secure manner (such as in an encrypted transmission and/or over a secure network) to the authorization service 120. In some embodiments, the information communicated within the encrypted transaction request may include a client identifier, a shared code provided by the purported client to the transaction request system, a request system identifier that identifies with the transaction request system 102, and information regarding the nature of the transaction (such as a balance amount to be transferred from the client's account to an account associated with the transaction request system, or a request for information regarding the client). In response to receiving the request, the authorization service 120 may decrypt the transaction request and validate the provided client identifier, the provided shared code, and the provided request system identifier by comparing the provided information to previously stored identifiers and associated codes in the requestor data repository 130 or client data repository 134, as appropriate.

If either of the provided identifiers or the provided shared code do not match the stored records, the authorization service 120 may send a transaction denial indication to the transaction request system 102 (denial not illustrated in FIG. 2). If the authorization service 102 instead successfully validates the provided identifiers and shared code, the authorization service 120 generates an authorization request message and sends the message to the client device 110 over a network, such as a cellular network. For example, the message may be an SMS message that includes human-readable text information regarding the requested transaction (such as by identifying the requestor), and may be sent to the mobile phone number associated with the provided client identifier in the client data repository 134.

As further illustrated in FIG. 2, the client device 110 may receive the authorization request message (such as an SMS message received via a cellular network of the client's cellular phone service provider) and may display the message on a display screen of the client device. The user of the client device 110 (who is most likely the client, unless the device has been cloned or stolen) may then enter a responsive text message on the client device 110. For example, the authorization message may prompt the client to enter the client's private code in a responsive text message if the client approves the transaction. In other embodiments, it may be assumed that the client knows that entering his private code in a responsive text message will approve the transaction (for example, the text content of the authorization message may not mention that a code is needed). If the client approves of the transaction (most likely because the client was the person that initiated the transaction at the transaction request system 102), the client may enter a responsive text message that includes his private code (such as an alphanumeric string or numeric digits) as text content of the message, and the client device may send the responsive text as an SMS message via a cellular network to the authorization service 120. If the client does not recognize the transaction (such as because the client was not the person that initiated the transaction request), the client may respond with message content that does not include the private code (such as a predetermined refusal string of “no,” in some embodiments) or may simply not respond. As will be appreciated, if the user of the client device 110 is not the actual client (such as because the client's device was stolen or cloned), the user will likely not know the client's private code and be unable to respond to the authorization message with the proper authorization.

If the authorization service 120 receives a responsive text message from the client device 110, the authorization service 120 searches the text content of the message for the client's private code (as retrieved by the authorization service 120 from the client data repository 134). In some embodiments, the authorization service 120 may apply one or more rules when determining whether the message provides sufficient authorization. For example, in one embodiment the private code may be required to be the only content of the message, while in other embodiments the authorization service 120 may allow the client to include a note, memo, or other content in the message for storing in a transaction data store in association with the transaction and/or for the authorization service 120 to provide to the transaction request system 102 when confirming the transaction. If the authorization service 120 successfully validates the transaction based on the client's response, the authorization service sends a transaction confirmation indication to the transaction request system 102. The authorization service may additionally perform other transaction steps upon validation according to the nature of the transaction (such as altering point or monetary balances associated with the requestor's account and the client account to reflect a transfer from the client's account to the requestor's account). If the authorization service 120 determines that the client has not successfully validated the transaction (such as because the client did not respond with the correct private code within a predetermined amount of time after the sending of the authorization request message), the authorization service 120 may send a transaction denial indication to the transaction request system 102. For example, in one embodiment, the authorization service 120 may start a timer for a predetermined amount of time (such as one minute) upon sending the authorization message, and may be configured to automatically consider the transaction request to have failed if a validated responsive text message is not received back from the client device prior to expiration of the timer.

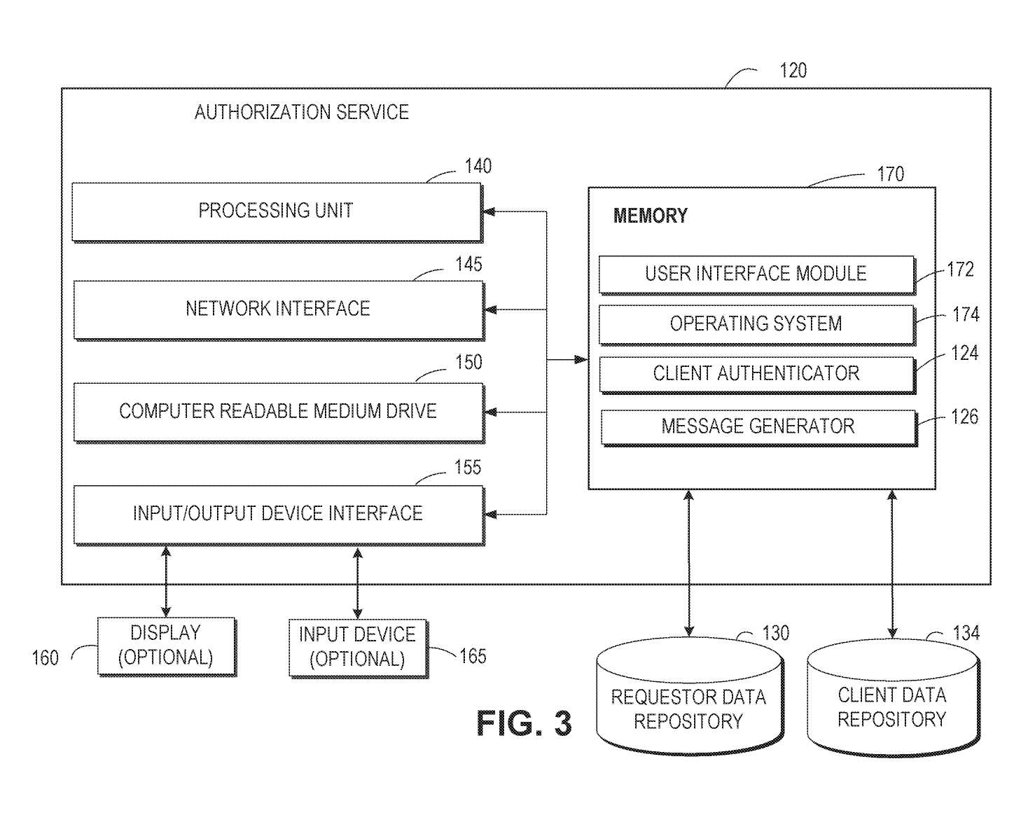

FIG. 3 depicts a general architecture of a computing system (referenced as authorization service 120) that may implement various aspects of the present disclosure, including communicating with both a transaction request system and a client device in determining whether to authorize an electronic transaction originating from a transaction request system or other remote system. The general architecture of the authorization service 120 depicted in FIG. 3 includes an arrangement of computer hardware and software components that may be used to implement aspects of the present disclosure. The authorization service 120 may include many more (or fewer) elements than those shown in FIG. 3. It is not necessary, however, that all of these generally conventional elements be shown in order to provide an enabling disclosure. As illustrated, the authorization service 120 includes a processing unit 140, a network interface 145, a computer readable medium drive 150, an input/output device interface 155, an optional display 160, and an optional input device 165, all of which may communicate with one another by way of a communication bus. The network interface 145 may provide connectivity to one or more networks or computing systems. In some embodiments, the network interface 145 may include cellular communications hardware, an Ethernet card, a modem, and/or WiFi communications hardware. Cellular communications hardware may include an antenna and other physical components such as a chip, SIM card(s), a radio transceiver, a modem and/or other hardware known in the art that is capable of sending and receiving information via a cellular network, such as a GSM network, LTE network or CDMA network. The processing unit 140 may thus send and receive information and instructions from other computing systems or services via a network, such as networks 108 and/or 109, and in some embodiments may interact with network interface 145 hardware to transmit and receive radio signals from a cellular network or other wireless network. The processing unit 140 may also communicate to and from memory 170 and further provide output information for an optional display 160 via the input/output device interface 155. The input/output device interface 155 may also accept input from the optional input device 165, such as a keyboard, mouse, digital pen, microphone, touch screen, gesture recognition system, voice recognition system, image recognition through an imaging device (which may capture eye, hand, head, body tracking data and/or placement), gamepad, accelerometer, gyroscope, or other input device known in the art.

The memory 170 may contain stored computer program instructions (which may be grouped as modules or components in some embodiments) that the processing unit 140 executes in order to implement one or more embodiments. The memory 170 generally includes RAM, ROM and/or other persistent, auxiliary or non-transitory computer readable media. The memory 170 may store an operating system 174 that provides computer program instructions for use by the processing unit 140 in the general administration and operation of the authorization service 120. The memory 170 may further include computer program instructions and other information for implementing aspects of the present disclosure. For example, in one embodiment, the memory 170 includes a user interface module 172 that generates user interfaces (and/or instructions therefor) for display upon a computing device, e.g., via a navigation interface such as a browser or application installed on the computing device. In addition, memory 170 may include or communicate with requestor data repository 130, client data repository 134 and/or one or more other data stores.

In addition to and/or in combination with the user interface module 172, the memory 170 may include a client authenticator 124 and a message generator 126 that may be executed by the processing unit 140. In one embodiment, the client authenticator 124 and message generator 126 individually or collectively implement various aspects of the present disclosure, e.g., validating client identifiers and codes, generating and sending authorization request messages, generating transaction confirmations and denials, etc., as described further below.

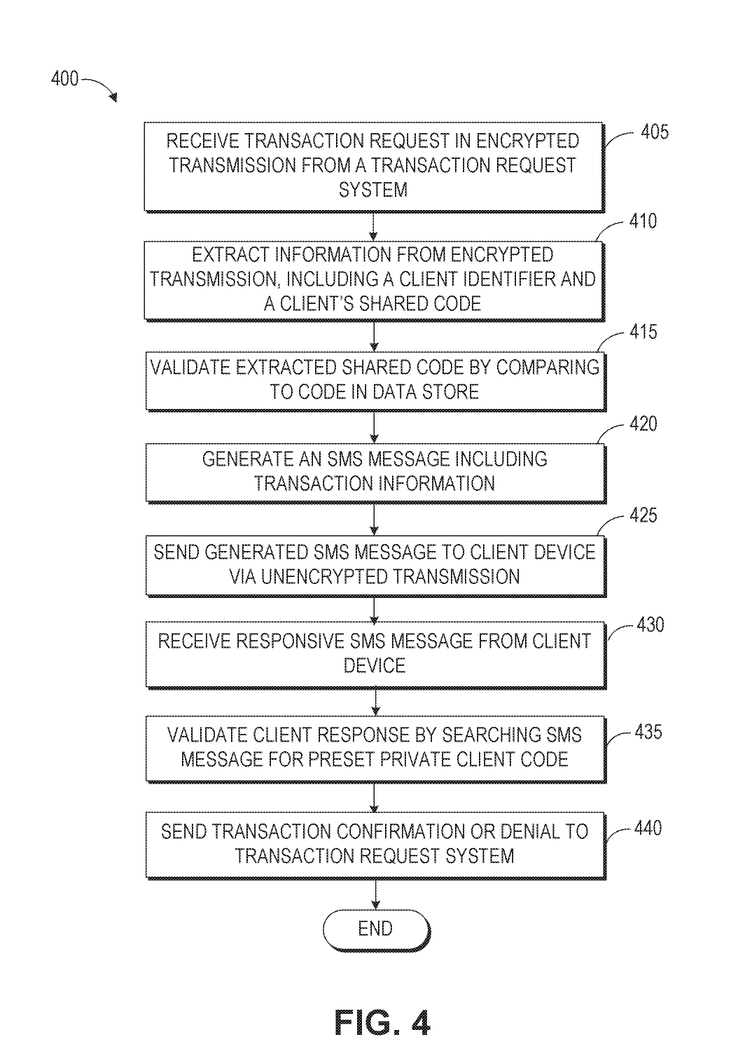

FIG. 4 is a flow diagram of an illustrative method 400 implemented by the authorization service 120 for authorizing an electronic transaction and/or authenticating the source of a transaction request. The illustrative method 400 is similar to that described above with respect to FIG. 2, although the flow diagram of FIG. 4 is from the perspective of the authorization service 120, such that each block of the flow diagram may be performed by the authorization service 120 (such as by one or more hardware processors that implement computer-executable instructions of the client authenticator 124 and/or message generator 126).

The illustrative method 400 begins at block 405, where the authorization service 120 receives a transaction request in an encrypted transmission and/or via an otherwise secure communication from a transaction request system, such as transaction request system 102. As discussed above, the transaction request may include a client identifier identifying one party to the requested transaction, a shared code purportedly associated with the account of the identified client, a requestor identifier identifying an owner or operator of the transaction request system 102 (e.g., the second party to the requested transaction), as well as optional additional information regarding the requested transaction. At block 410, the client authenticator 124 may extract the various information elements from the encrypted transmission, such as by decrypting the transmitted data and extracting each data element (e.g., the client identifier, the client's code, etc.) from fields or other portions of the transmitted request information.

At block 415, the client authenticator 124 may validate the extracted shared code by comparing the extracted code to the client's shared code stored in the client data repository 134, as previously described above. If the shared code does not match, the transaction request may be denied and the illustrative method may end (not illustrated). If the shared code matches, the illustrative method proceeds to block 420, where the message generator 126 generates an authorization message (such as an SMS message) for the client, as described above, and sends the message to the client device at block 425. As previously described, the message may be sent in an unencrypted form due to technical limitations of the client's device, yet the overall transaction protocol may remain relatively secure due to the other safeguards (such as the use of both a private and shared code that may each be sent via different networks between different systems).

At block 430, the client authenticator 124 may receive a responsive message (such as an SMS message) from the client device, likely in an unencrypted form depending on the technical capabilities of the particular client device. As previously described with reference to FIG. 2, the client authenticator 124 may then validate the client response by searching the responsive message from the client device for the preset private code associated with the client's account, at block 435. At block 440, depending on the results of the validation block 435, the authorization service 120 may generate and send a transaction confirmation or denial indication to the transaction request system, as well as perform any transaction-specific actions. A transaction-specific action in a given embodiment may include, for example, debiting an account of the client, crediting an account of the requestor, releasing electronic information (such as personal information or otherwise confidential information regarding the client or the client's account), releasing an electronic document associated with the client's account (such as an electronic credential, medical records, a passport, financial records, etc.) and/or any other action that a client and/or transaction requestor may have requested and for which the authorization service 120 has been configured in a given embodiment.

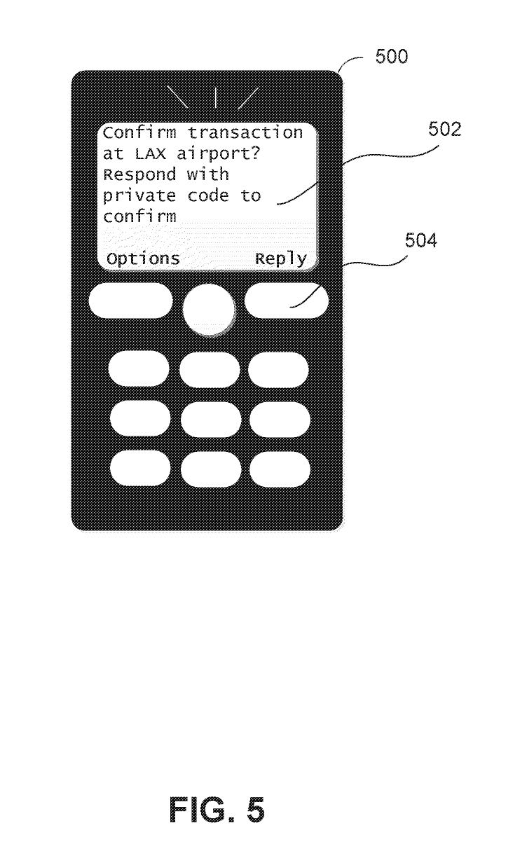

FIG. 5 depicts an example text message 502, as displayed on a mobile computing device 500, which may have been generated by authorization service 120 and sent to the mobile computing device 500 as an SMS message via a cellular network. The text content of illustrative message 502 reads “Confirm transaction at LAX airport? Respond with private code to confirm.” Those of skill in the art will appreciate that the wording of information and extent of transaction information included in the message may vary widely depending on the transaction purpose and the embodiment. For example, in a financial transaction, the message may indicate a monetary amount or point amount requested to be transferred from the client's account to an identified recipient. As another example, in a transaction request for the electronic release of information, the message may include an indication of the information requested by the requestor (e.g., “Would you like to release your passport information to authorities at LAX airport?”). In the illustrated example, the user of device 500 may press a physical button 504 on the device 500 in order to begin composing a responsive text message, in which the user may enter his private code using numeric or alphanumeric buttons. In other embodiments, various different methods and mechanisms for entering responsive text messages may be utilized depending on the specific hardware and software associated with the user's device. For example, the user may provide input via a touchscreen, external keyboard, gestures, voice, or in any other manner supported by the given device.

In some embodiments, various additional security measures may be implemented by the authorization service beyond those described above. For example, the authorization service 120 may maintain in client data repository 134, a third code for each client, in addition to the private code and the shared code described above. In some embodiments, the client may be required to provide the third code to the authorization service in order to make changes to his account, such as to change either the given client's private code or the shared code.

According to some embodiments, the authorization service may maintain a record of the technical capabilities of each client's device(s) in client data repository (such as whether the device has Internet access, supports encryption, may receive push notifications, has an application associated with the authorization service 120 installed on the device, etc.) and may send transaction authorization messages and other communications to a given client device in a different form depending on the capabilities of the device. For example, if the authorization service has determined that a given client has a smartphone and/or appropriate application on his device, the authorization service 120 may send messages to that device via an encrypted message, a push notification delivered via a proprietary application on the device, and/or in some other manner.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

Processes described herein may be embodied in, and fully automated via, software code modules executed by a computing system that includes one or more general purpose computers or processors. The code modules may be stored in any type of non-transitory computer-readable medium or other computer storage device. Some or all the methods may alternatively be embodied in specialized computer hardware. In addition, the components referred to herein may be implemented in hardware, software, firmware or a combination thereof.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks, modules, and algorithm elements described in connection with the embodiments disclosed herein can be implemented as electronic hardware, computer software, or combinations of both. To clearly illustrate this interchangeability of hardware and software, various illustrative components, blocks, modules, and elements have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, or algorithm described in connection with the embodiments disclosed herein can be embodied directly in hardware, in a software module stored in one or more memory devices and executed by one or more processors, or in a combination of the two. A software module can reside in RAM memory, flash memory, ROM memory, EPROM memory, EEPROM memory, registers, hard disk, a removable disk, a CD-ROM, or any other form of non-transitory computer-readable storage medium, media, or physical computer storage known in the art. An example storage medium can be coupled to the processor such that the processor can read information from, and write information to, the storage medium. In the alternative, the storage medium can be integral to the processor. The storage medium can be volatile or nonvolatile.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

It should be emphasized that many variations and modifications may be made to the above-described embodiments, the elements of which are to be understood as being among other acceptable examples. All such modifications and variations are intended to be included herein within the scope of this disclosure.

What is claimed is:

1. An authentication system for securely authorizing an electronic transaction, the system comprising:
an electronic data store configured to store authentication information associated with each of a plurality of electronic accounts, wherein authentication information for a first account of the plurality of accounts comprises at least a first client identifier, a shared code and a private code;
cellular communications hardware, including an antenna, that is configured to send radio signals via a cellular network; and
a physical processor in communication with the electronic data store and the cellular communications hardware, wherein the physical processor is configured with processor-executable instructions to perform operations comprising at least:
receiving an electronic transaction request from a first computing device, wherein the electronic transaction request is received within an encrypted transmission via one of a wired network transmission or a wireless network transmission;
determining a client identifier and a first code within the electronic transaction request at least in part by processing the encrypted transmission;
determining that the electronic transaction request corresponds to the first account at least in part by matching the client identifier within the electronic transaction request with the first client identifier stored in the electronic data store;
validating the first code, wherein validating the first code comprises determining that the first code within the electronic transaction request matches the shared code associated with the first account in the electronic data store;
generating a text message that includes (a) information regarding the electronic transaction request and (b) a request for transaction authorization;
sending the text message, via the cellular communications hardware, for delivery to a mobile computing device having a phone number that is stored in the electronic data store in association with the first account, wherein the text message is sent in an unencrypted form using a Short Message Service (SMS) communications protocol;
receiving a responsive text message from the mobile computing device;
validating the responsive text message, wherein validating the responsive text message comprises determining that at least a portion of text content within the responsive text message includes the private code associated with the first account in the electronic data store; and
based at least in part on a determination that the at least a portion of the text content within the responsive text message includes the private code associated with the first account, sending an electronic transaction approval indication to the first computing device.

2. The system of claim 1, wherein the operations further comprise, based at least in part on the determination that the at least a portion of the text content within the responsive text message includes the private code:
sending an electronic document associated with the first account to the first computing device.

3. The system of claim 1, wherein the operations further comprise, based at least in part on the determination that the at least a portion of the text content within the responsive text message includes the private code:
modifying a stored numeric account balance associated with the first account to reflect a completed transaction.

4. The system of claim 1, wherein the shared code is a first alphanumeric string or a first plurality of numeric digits, wherein the private code is a second alphanumeric string or a second plurality of numeric digits.

5. The system of claim 1, wherein the first client identifier is the phone number stored in association with the first account.

6. The system of claim 1, wherein the first client identifier and the phone number stored in association with the first account are different.

7. The system of claim 1, wherein the electronic transaction request is received from the first computing device based at least in part on user interaction with a webpage.

8. The system of claim 7, wherein the encrypted transmission is encrypting using one of Transport Layer Security or Secure Sockets Layer.

9. The system of claim 1, wherein the electronic transaction request is received from the first computing device based at least in part on execution of an application by the first computing device, wherein the application was previously installed on the first computing device and is associated with an operator of the computing system.

10. A computer-implemented method comprising:
as implemented by a computer system executing specific computer-executable instructions,
receiving an electronic transaction request from a first computing device, wherein the electronic transaction request is received within an encrypted transmission;
determining a client identifier and a first code within the electronic transaction request at least in part by processing the encrypted transmission;
determining that the electronic transaction request corresponds to a first account at least in part by matching the client identifier within the electronic transaction request with a client identifier stored in an electronic data store;
validating the first code, wherein validating the first code comprises determining that the first code within the electronic transaction request matches a shared code associated with the first account in the electronic data store;
generating a text message that includes a request for transaction authorization;
sending the text message to a mobile computing device using a phone number stored in the electronic data store in association with the first account, wherein the text message is sent in an unencrypted form via a cellular network;
receiving a responsive text message from the mobile computing device;
validating the responsive text message, wherein validating the responsive text message comprises determining that at least a portion of text content within the responsive text message includes a private code previously associated with the first account in the electronic data store; and
based at least in part on a determination that the at least a portion of the text content within the responsive text message includes the private code associated with the first account, sending an electronic transaction approval indication to the first computing device.

11. The computer-implemented method of claim 10, further comprising:
receiving a second electronic transaction request from a second computing device, wherein the second electronic transaction request is received within an encrypted transmission;
determining a client identifier and a first code within the electronic transaction request at least in part by decrypting the encrypted transmission;
determining that the second electronic transaction request corresponds to the first account;
validating a first code within the second electronic transaction request, wherein validating the first code comprises determining that the first code within the second electronic transaction request matches the shared code associated with the first account in the electronic data store;
generating a second text message that includes a second request for transaction authorization;
sending the second text message to the mobile computing device using the phone number stored in the electronic data store in association with the first account.

12. The computer-implemented method of claim 11, further comprising:
receiving a second responsive text message from the mobile computing device subsequent to sending the second text message;
determining that the second responsive text message from the mobile computing device does not include the private code previously associated with the first account in the electronic data store; and
based at least in part on a determination that the second responsive text message from the mobile computing device does not include the private code, sending an electronic transaction denial indication to the first computing device.

13. The computer-implemented method of claim 11, further comprising:
determining that no text message response from the mobile computing device has been received within a predetermined amount of time after sending the second text message to the mobile computing device; and
based at least in part on a determination that no text message response from the mobile computing device has been received within a predetermined amount of time, sending an electronic transaction denial indication to the first computing device.

14. The computer-implemented method of claim 10, wherein the text message is sent using a Short Message Service (SMS) communications protocol.

15. The computer-implemented method of claim 10, wherein the shared code is a first alphanumeric string or a first plurality of numeric digits, wherein the private code is a second alphanumeric string or a second plurality of numeric digits.

16. The computer-implemented method of claim 10, further comprising, prior to generating the text message that includes the request for transaction authorization:
confirming that a request system identifier within the electronic transaction request matches a previously stored requestor identifier.

17. The computer-implemented method of claim 10, further comprising:
in response to the determination that the at least a portion of the text content within the responsive text message includes the private code associated with the first account, sending information to the first computing device regarding an individual associated with the first account.

18. The computer-implemented method of claim 10, further comprising:
in response to the determination that the at least a portion of the text content within the responsive text message includes the private code associated with the first account, debiting an account balance stored in association with the first account.

19. A computing system comprising:
an electronic data store configured to store authentication information associated with each of a plurality of electronic accounts, wherein authentication information for a first account of the plurality of accounts comprises at least a first client identifier, a shared code and a private code; and
a physical processor in communication with the electronic data store and configured with processor-executable instructions to perform operations comprising at least:
receiving an electronic transaction request from a first computing device, wherein the electronic transaction request is received within an encrypted transmission;
determining a client identifier and a first code within the electronic transaction request;
determining that the electronic transaction request corresponds to the first account at least in part by matching the client identifier within the electronic transaction request with the first client identifier stored in the electronic data store;
validating the first code, wherein validating the first code comprises determining that the first code within the electronic transaction request matches the shared code associated with the first account in the electronic data store;
generating a text message that includes textual content comprising requestor information associated with the electronic transaction request, wherein the requestor information is at least one of a location or a name of a requesting entity;
sending the text message to a mobile computing device using a phone number stored in the electronic data store in association with the first account;
receiving a responsive text message from the mobile computing device;
validating the responsive text message, wherein validating the responsive text message comprises determining that at least a portion of text content within the responsive text message includes the private code associated with the first account in the electronic data store; and
based at least in part on a determination that the at least a portion of the text content within the responsive text message includes the private code associated with the first account, sending an electronic transaction approval indication to the first computing device.

20. The system of claim 19, wherein the text message is sent in an unencrypted form using a Short Message Service (SMS) communications protocol.
